(19) United States
(12) Patent Application Publication
(10) Pub. No.: US 2022/0319385 A1
(43) Pub. Date: Oct. 6, 2022

(54) TIMING CONTROLLER, CONTROLLING METHOD THEREOF, AND DISPLAY DEVICE WITH THE TIMING CONTROLLER

(71) Applicant: TCL CHINA STAR OPTOELECTRONICS TECHNOLOGY CO., LTD., Shenzhen, Guangdong (CN)

(72) Inventor: Guangxing XIAO, Shenzhen, Guangdong (CN)

(21) Appl. No.: 17/054,750

(22) PCT Filed: Oct. 15, 2020
(86) PCT No.: PCT/CN2020/121144

§ 371 Date: Nov. 11, 2020

(30) Foreign Application Priority Data
Sep. 10, 2020 (CN) 202010945252.7

(51) Int. Cl. G09G 3/20

(52) U.S. Cl. CPC G09G 3/2092; G09G 2310/0291; G09G 2360/18

(57) ABSTRACT

The present invention provides a timing controller and a controlling method thereof, and a display device with the timing controller. The timing controller includes a storage control module and a frame buffer module connected to each other, and a self-refresh interface connected to the front-end system chip. When the front-end system chip displays a static screen image, the timing controller provided by the present invention can only maintain internal essential modules working and suspend other modules on standby, which reduces power consumption of the timing controller and enhances an operation life of the display device with the timing controller.

### FIELD OF INVENTION

The present invention relates to a field of display technologies, especially relates to a timing controller, a controlling method thereof, and a display device with the timing controller.

### BACKGROUND OF INVENTION

At present, under a circumstance of a liquid crystal display screen displaying a static screen image of an electronic book or a website page of a browser, a timing controller controlling the liquid crystal display screen still keeps working such that the electricity is wasted drastically and a power consumption of the timing controller becomes greater, which leads to a greater power consumption of the liquid crystal display screen.

### SUMMARY OF INVENTION

Technical issue

At present, a liquid crystal display screen displaying a static screen image of an electronic book or a website page of a browser has a greater power consumption.

Technical solution

For lowering the power consumption of a timing controller when the liquid crystal display screen displays a static screen image, the present invention provides a timing controller, a controlling method thereof, and a display device with the timing controller.

In a first aspect, the present invention provides a timing controller, comprising a storage control module and a frame buffer module connected to each other, wherein the timing controller further comprises a self-refresh interface connected to a front-end system chip, and the self-refresh interface is configured to detect whether the front-end system chip outputs a static screen image; wherein when the self-refresh interface detects the static screen image, the storage control module writes the static screen image into the frame buffer module, and controls the frame buffer module to output the static screen image.

In some embodiments, the timing controller further comprises a row buffer module connected to the storage control module; and after the static screen image is written into the frame buffer module, the storage control module sequentially outputs rows of pixel data of each frame of the static screen image at least one row at a time from the frame buffer module through the row buffer module.

In some embodiments, the timing controller further comprises a data reception module connected to the storage control module and a data output module connected to the row buffer module; the data reception module is configured to receive the static screen image outputted by the front-end system chip and to output the pixel data of each frame of the static screen image to the frame buffer module; and the data output module is configured to receive at least one row of the pixel data outputted by the row buffer module and output the at least one row of the pixel data.

In some embodiments, the timing controller further comprises a gate and source electrode timing control signal generation module connected to the row buffer module; and the gate and source electrode timing control signal module is configured to generate a gate electrode timing control signal and a source electrode timing control signal.

In some embodiments, the timing controller further comprises a micro process module, and the front-end system chip and the storage control module are connected to the micro process module; and the micro process module is configured to control the storage control module to receive data and instructions transmitted by the front-end system chip.

In some embodiments, the timing controller further comprises a phase lock loop module; and the phase lock loop module is configured to generate clock frequencies of the storage control module, the data output module, and the micro process module.

In some embodiments, the storage control module comprises a detect unit and a control unit; the detect unit is configured to detect an effective data strobe signal of the static screen image; the control unit is configured to control the frame buffer module to transmit the pixel data of the static screen image form the frame buffer module to the row buffer module in a cycle when an effective data strobe signal is detected in the cycle.

In a second aspect, the present invention also provides a controlling method for controlling a timing controller, the timing controller comprising a storage control module and a frame buffer module connected to each other, wherein the timing controller further comprises a self-refresh interface connected to a front-end system chip, and the controlling method comprises:

by the self-refresh interface detecting any one static screen image outputted by the front-end system chip;

by the storage control module writing the static screen image into the frame buffer module; and

by the storage control module outputting the static screen image from the frame buffer module.

In some embodiments, the timing controller further comprises a row buffer module connected to the storage control module, the step of by the storage control module outputting the static screen image from the frame buffer module in the controlling method further comprises:

by the storage control module sequentially outputting the pixel data of each frame of the static screen image at least one row at a time from the frame buffer module through the row buffer module.

In a third aspect, the present invention further provides a display device, comprising: a display panel, a gate electrode driver configured to provide the display panel with a scan signal, a source electrode driver configured to provide the display panel with a data signal, and a timing controller, wherein the timing controller is configured to provide the gate electrode driver with a gate electrode timing control signal and to provide the source electrode driver with a source electrode timing control signal and pixel data of a static screen image;

where in the timing controller comprises a storage control module and a frame buffer module connected to each other, the timing controller further comprises a self-refresh interface connected to a front-end system chip, and the self-refresh interface is configured to detect whether the front-end system chip outputs the static screen image; and

wherein when the self-refresh interface detects the static screen image, the storage control module writes the static screen image into the frame buffer module, and controls the frame buffer module to output the static screen image.

In some embodiments, the timing controller further comprises a row buffer module connected to the storage control module; and

after the static screen image is written into the frame buffer module, the storage control module sequentially outputs rows of pixel data of each frame of the static screen image at least one row at a time from the frame buffer module through the row buffer module.

In some embodiments, the timing controller further comprises a data reception module connected to the storage control module and a data output module connected to the row buffer module;

the data reception module is configured to receive the static screen image outputted by the front-end system chip and to output the pixel data of each frame of the static screen image to the frame buffer module; and

the data output module is configured to receive at least one row of the pixel data outputted by the row buffer module and output the at least one row of the pixel data.

In some embodiments, the timing controller further comprises a gate and source electrode timing control signal generation module connected to the row buffer module; and

the gate and source electrode timing control signal module is configured to generate a gate electrode timing control signal and a source electrode timing control signal.

In some embodiments, the timing controller further comprises a micro process module, and the front-end system chip and the storage control module are connected to the micro process module; and

the micro process module is configured to control the storage control module to receive data and instructions transmitted by the front-end system chip.

In some embodiments, the timing controller further comprises a phase lock loop module; and

the phase lock loop module is configured to generate clock frequencies of the storage control module, the data output module, and the micro process module.

In some embodiments, the storage control module comprises a detect unit and a control unit;

the detect unit is configured to detect an effective data strobe signal of the static screen image; and

the control unit is configured to control the frame buffer module to transmit the pixel data of the static screen image form the frame buffer module to the row buffer module in a cycle when an effective data strobe signal is detected in the cycle.

Advantages

In the timing controller, the controlling method thereof, and the display device comprises the timing controller provided by the present invention, the timing controller comprises the storage control module and the frame buffer module connected to each other and the self-refresh interface connected to the front-end system chip. When the timing controller uses the self-refresh interface to detect a static screen image outputted by the front-end system chip, the storage control module writes the static screen image received by the front-end system chip into the frame buffer module for storage, and then outputs the static screen image out from the frame buffer module according to a normal timing. When the front-end system chip displays a static screen image, the timing controller provided by the present invention can only maintain internal essential modules such as the storage control module and the frame buffer module working and suspend other modules on standby, which reduces power consumption of the timing controller and enhances an operation life of the display device with the timing controller.

DESCRIPTION OF DRAWINGS

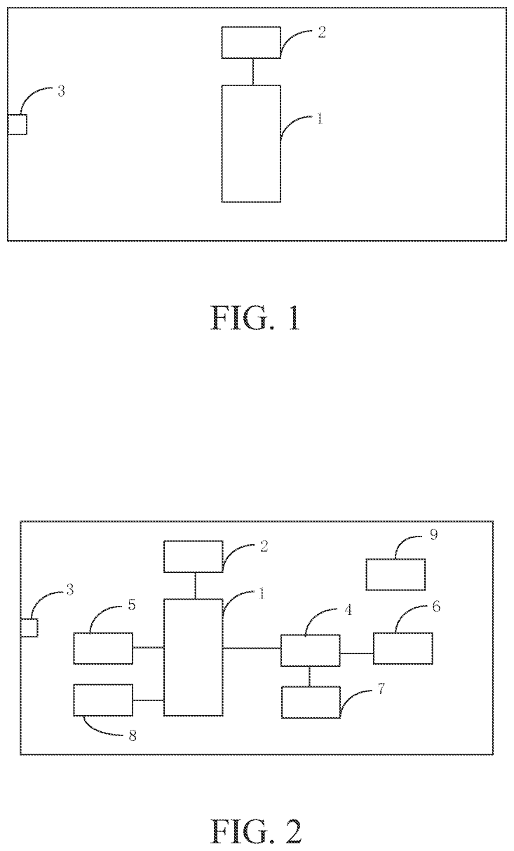

FIG. 1 is a basic schematic structural view of a timing controller provided by an embodiment of the present invention.

FIG. 2 is a schematic structural view of the timing controller provided by the embodiment of the present invention.

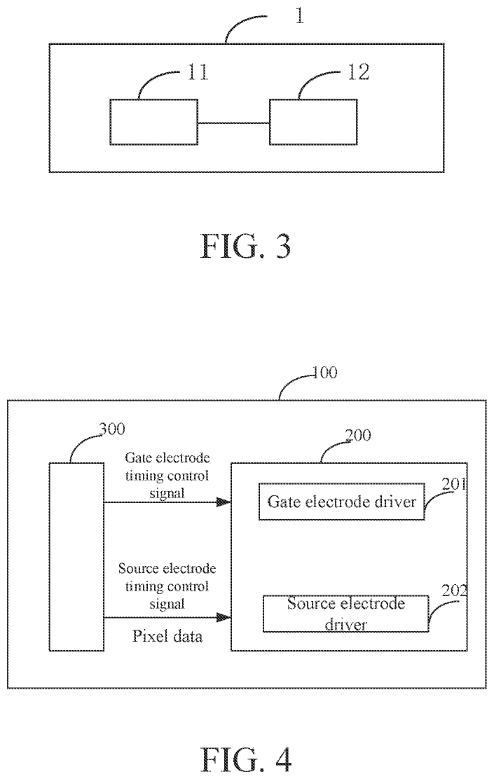

FIG. 3 is a schematic structural view of a storage control module of the timing controller provided by the embodiment of the present invention.

FIG. 4 is a schematic structural view of a display device provided by an embodiment of the present invention.

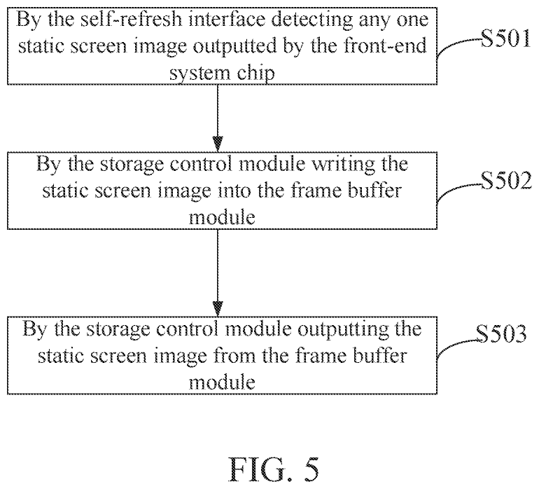

FIG. 5 is a flowchart of a timing controller controlling method provided by the embodiment of the present invention.

### DETAILED DESCRIPTION OF PREFERRED EMBODIMENTS

To make the objective, the technical solution, and the effect of the present invention clearer and more explicit, the present invention will be further described in detail below with reference to the accompanying drawings. It should be understood that the specific embodiments described here are only used to explain the present invention instead of being used to limit the present invention.

FIG. 1 is a basic schematic structural view of a timing controller provided by an embodiment of the present invention. With reference to FIG. 1, the timing controller comprises a storage control module 1 and a frame buffer module 2 connected to each other and a self-refresh interface 3 connected to a front-end system chip (not shown). The self-refresh interface 3 is configured to detect whether the front-end system chip outputs a static screen image. When the self-refresh interface 3 detects that the front-end system chip any one static screen image, the storage control module 1 writes the static screen image received by the front-end system chip into the frame buffer module 2 and then outputs the static screen image out from the frame buffer module 2.

Specifically, the self-refresh interface 3 determines whether the front-end system chip outputs a static screen image through an electrical level transmitted by the front-end system chip. For example, the front-end system chip transmits a low electrical level to the self-refresh interface 3 while normally outputting a screen image to the timing controller. The front-end system chip transmits a high electrical level to the self-refresh interface 3 while outputting a static screen image to the timing controller, namely, the self-refresh interface 3 determines that an effective electrical level of the static screen image outputted by the front-end system chip is a high electrical level. It should be explained that switching between high and low electrical levels is implemented in a vertical blank (Vblank) time interval. The vertical blank time interval refers to an interval from a last row of pixels of an active area (AA) written with data of a screen image of a previous frame to a first row of the pixels written with data of a screen image of a next frame.

When the front-end system chip displays a static screen image, the timing controller provided by the present invention can only maintain internal essential modules such as the storage control module and the frame buffer module working and suspend other modules on standby, which reduces power consumption of the timing controller.

FIG. 2 is a schematic structural view of the timing controller provided by the embodiment of the present invention. With reference to FIG. 2, the timing controller further comprises a row buffer module 4 connected to the storage control module 1. After the frame buffer module 2 writes the static screen image, the storage control module 1 sequentially outputs pixel data of each frame of the static screen image at least one row at a time the frame buffer module 2 through row buffer module 4. The row buffer module 4 can store and output one or more rows of pixel data.

Furthermore, with reference to FIG. 2, the timing controller further comprises a data reception module 5 connected to the storage control module 1 and a data output module 6 connected to the row buffer module 4. The data reception module 5 is configured to receive a static screen image from the front-end system chip and output pixel data of each frame of the static screen image to the frame buffer module 2. The data output module 6 is configured to receive outputted by the row buffer module 4 and output the at least one row of pixel data.

Furthermore, with reference to FIG. 2, the timing controller further comprises a gate and source electrode timing control signal module 7 connected to the row buffer module 4. The gate and source electrode timing control signal module 7 is configured to generate a gate electrode timing control signal and a source electrode timing control signal.

Furthermore, with reference to FIG. 2, timing controller further comprises a micro process module 8. The front-end system chip and the storage control module 1 are connected to the micro process module 8. The micro process module 8 is configured to control the storage control module 1 to receive data and instructions transmitted by the front-end system chip.

Furthermore, with reference to FIG. 2, timing controller further comprises a phase lock loop module 9, and the phase lock loop module 9 is configured to generate clock frequencies of the storage control module 1, the data output module 6, and the micro process module 8. It should be explained that phase lock loop module 9 can comprise a plurality of phase lock loops configured to generate working frequencies of the storage control module 1, the data output module 6, and the micro process module 8.

According to the above embodiment, when the self-refresh interface 3 detects that the front-end system chip outputs a static screen image, in the timing controller, the row buffer module 4, the data output module 6, the data reception module 5, the gate and source electrode timing control signal module 7, the micro process module 8, and the phase lock loop module 9 are also operating simultaneously with the storage control module 1 and the frame buffer module 2. An operation process of the timing controller is as follows. Under control of the storage control module 1, the data reception module 5 receives a static screen image inputted by the front-end system chip and store the static screen image in the frame buffer module 2, and then transmits the static screen image from the frame buffer module 2 to the row buffer module 4 for storage according to a timing by one or more rows of pixel data. Finally the row buffer module 4 sequentially outputs one or more rows of pixel data through the data output module 6 to output the pixel data of an entire frame of the static screen image.

Specifically, FIG. 3 is a schematic structural view of a storage control module 1 of the timing controller provided by the embodiment of the present invention. With reference to FIG. 3, the storage control module 1 comprises a detect unit 11 and a control unit 12. The detect unit 11 is configured to detect an effective data strobe signal of the static screen image. The control unit 12 is configured to control the frame buffer module 2 to transmit the pixel data of the static screen image form the frame buffer module 2 to the row buffer module 4 in a cycle when an effective data strobe signal is detected in the cycle.

FIG. 4 is a schematic structural view of a display device provided by an embodiment of the present invention. With reference to FIG. 4, the display device 100 comprises: a display panel 200, a gate electrode driver 201 configured to provide the display panel 200 with a scan signal, a source electrode driver 202 configured to provide the display panel 200 with a data signal, and the timing controller 300 as described above. The timing controller 300 is configured to provide the gate electrode driver 201 with a gate electrode timing control signal, and provide the source electrode driver 202 with a source electrode timing control signal and pixel data of the static screen image.

Specifically, the timing controller 300 outputs a gate electrode timing control signal from the gate and source electrode timing control signal module 7 to the gate electrode driver 201, and outputs a source electrode timing control signal into source electrode driver 202 to implement a gate electrode timing control and a source electrode timing control. Moreover, the timing controller transmits pixel data of the static screen image from the data output module 6 to source electrode driver 202.

It should be explained that the gate electrode driver 201 and the source electrode driver 202 of the display device are not necessarily disposed inside the display panel 200. In FIG. 4, a position relation between the gate electrode driver 201 and the source electrode driver 202 and the display panel 200 are only exemplary.

FIG. 5 is a flowchart of a timing controller controlling method provided by the embodiment of the present invention. With reference to FIGS. 1 and 5, the present invention also provides a timing controller controlling method. The timing controller comprises a storage control module 1 and a frame buffer module 2 connected to each other and a self-refresh interface 3 connected to a front-end system chip. The controlling method comprises steps S501 to S503 as follows.

The step S501 comprises by the self-refresh interface 3 detecting any one static screen image outputted by the front-end system chip.

The step S502 comprises by the storage control module 1 writes the static screen image into the frame buffer module 2.

The step S503 comprises by the storage control module 1 outputs the static screen image out from the frame buffer module 2.

When the front-end system chip displays a static screen image, the timing controller controlling method provided by the present invention can only maintain internal essential modules such as the storage control module 1 and the frame buffer module 2 working and suspend other modules on standby, which reduces power consumption of the timing controller.

Furthermore, with reference to FIG. 2, the timing controller further comprises a row buffer module 4 connected to the storage control module 1. The step S503 in the controlling method of by the storage control module 1 outputting the static screen image out from the frame buffer module 2, specifically comprises:

After the frame buffer module 2 writes the static screen image, the storage control module 1 sequentially outputs the pixel data of each frame of the static screen image at least one row at a time from the frame buffer module 2 through the row buffer module 4.

It can be understood that for a person of ordinary skill in the art, equivalent replacements or changes can be made according to the technical solution of the present invention and its inventive concept, and all these changes or replacements should belong to the scope of protection of the appended claims of the present invention.

What is claimed is:

1. A timing controller, comprising a storage control module and a frame buffer module connected to each other, wherein the timing controller further comprises a self-refresh interface connected to a front-end system chip, and the self-refresh interface is configured to detect whether the front-end system chip outputs a static screen image;
wherein when the self-refresh interface detects the static screen image, the storage control module writes the static screen image into the frame buffer module, and controls the frame buffer module to output the static screen image.

2. The timing controller as claimed in claim 1, wherein
the timing controller further comprises a row buffer module connected to the storage control module; and
after the static screen image is written into the frame buffer module, the storage control module sequentially outputs rows of pixel data of each frame of the static screen image at least one row at a time from the frame buffer module through the row buffer module.

3. The timing controller as claimed in claim 2, wherein
the timing controller further comprises a data reception module connected to the storage control module and a data output module connected to the row buffer module;
the data reception module is configured to receive the static screen image outputted by the front-end system chip and to output the pixel data of each frame of the static screen image to the frame buffer module; and
the data output module is configured to receive at least one row of the pixel data outputted by the row buffer module and output the at least one row of the pixel data.

4. The timing controller as claimed in claim 2, wherein
the timing controller further comprises a gate and source electrode timing control signal generation module connected to the row buffer module; and
the gate and source electrode timing control signal module is configured to generate a gate electrode timing control signal and a source electrode timing control signal.

5. The timing controller as claimed in claim 3, wherein
the timing controller further comprises a micro process module, and the front-end system chip and the storage control module are connected to the micro process module; and
the micro process module is configured to control the storage control module to receive data and instructions transmitted by the front-end system chip.

6. The timing controller as claimed in claim 5, wherein
the timing controller further comprises a phase lock loop module; and
the phase lock loop module is configured to generate clock frequencies of the storage control module, the data output module, and the micro process module.

7. The timing controller as claimed in claim 2, wherein
the storage control module comprises a detect unit and a control unit;
the detect unit is configured to detect an effective data strobe signal of the static screen image; and
the control unit is configured to control the frame buffer module to transmit the pixel data of the static screen image form the frame buffer module to the row buffer module in a cycle when an effective data strobe signal is detected in the cycle.

8. A controlling method for controlling a timing controller, the timing controller comprising a storage control module and a frame buffer module connected to each other, wherein the timing controller further comprises a self-refresh interface connected to a front-end system chip, and the controlling method comprises:
by the self-refresh interface detecting any one static screen image outputted by the front-end system chip;
by the storage control module writing the static screen image into the frame buffer module; and
by the storage control module outputting the static screen image from the frame buffer module.

9. The controlling method as claimed in claim 8, wherein the timing controller further comprises a row buffer module connected to the storage control module, the step of by the storage control module outputting the static screen image from the frame buffer module in the controlling method further comprises:
by the storage control module sequentially outputting the pixel data of each frame of the static screen image at least one row at a time from the frame buffer module through the row buffer module.

10. A display device, comprising: a display panel, a gate electrode driver configured to provide the display panel with a scan signal, a source electrode driver configured to provide the display panel with a data signal, and a timing controller, wherein the timing controller is configured to provide the gate electrode driver with a gate electrode timing control signal and to provide the source electrode driver with a source electrode timing control signal and pixel data of a static screen image;
wherein the timing controller comprises a storage control module and a frame buffer module connected to each other, the timing controller further comprises a self-refresh interface connected to a front-end system chip, and the self-refresh interface is configured to detect whether the front-end system chip outputs the static screen image; and
wherein when the self-refresh interface detects the static screen image, the storage control module writes the static screen image into the frame buffer module, and controls the frame buffer module to output the static screen image.

11. The display device as claimed in claim 10, wherein
the timing controller further comprises a row buffer module connected to the storage control module; and
after the static screen image is written into the frame buffer module, the storage control module sequentially outputs rows of pixel data of each frame of the static screen image at least one row at a time from the frame buffer module through the row buffer module.

12. The display device as claimed in claim 11, wherein the timing controller further comprises a data reception module connected to the storage control module and a data output module connected to the row buffer module;
the data reception module is configured to receive the static screen image outputted by the front-end system chip and to output the pixel data of each frame of the static screen image to the frame buffer module; and
the data output module is configured to receive at least one row of the pixel data outputted by the row buffer module and output the at least one row of the pixel data.

13. The display device as claimed in claim 11, wherein the timing controller further comprises a gate and source electrode timing control signal generation module connected to the row buffer module; and
the gate and source electrode timing control signal module is configured to generate a gate electrode timing control signal and a source electrode timing control signal.

14. The display device, as claimed in claim 12 wherein
the timing controller further comprises a micro process module, and the front-end system chip and the storage control module are connected to the micro process module; and
the micro process module is configured to control the storage control module to receive data and instructions transmitted by the front-end system chip.

15. The display device as claimed in claim 14, wherein the timing controller further comprises a phase lock loop module; and
the phase lock loop module is configured to generate clock frequencies of the storage control module, the data output module, and the micro process module.

16. The display device as claimed in claim 11, wherein
the storage control module comprises a detect unit and a control unit;
the detect unit is configured to detect an effective data strobe signal of the static screen image; and
the control unit is configured to control the frame buffer module to transmit the pixel data of the static screen image form the frame buffer module to the row buffer module in a cycle when an effective data strobe signal is detected in the cycle.
